(19) United States
(12) Patent Application Publication
(10) Pub. No.: US 2016/0201827 A1
(43) Pub. Date: Jul. 14, 2016

(54) QUICK MOUNT/RELEASE, MICRO-FLUIDIC VALVE ASSEMBLY

(71) Applicant: IDEX Health & Science LLC, Northbrook, IL (US)

(72) Inventor: Christopher R. TOWER, Santa Rosa, CA (US)

(21) Appl. No.: 14/993,346

(22) Filed: Jan. 12, 2016

Related U.S. Application Data
(60) Provisional application No. 62/102,722, filed on Jan. 13, 2015.

(51) Int. Cl. F16K 99/00

(52) U.S. Cl. CPC F16K 99/0003; F16K 2099/0086

(57) ABSTRACT

A quick-mount/release, multi-position, micro-fluidic valve system including an actuator assembly and an interchangeable valve assembly. The actuator assembly includes an actuator housing providing a distal receiving cavity, and rotably supporting an actuator shaft therein. The valve assembly includes a POD housing rotably supporting a valve shaft, and a proximal insert portion formed and dimensioned for sliding axial receipt in the receiving cavity of the actuator assembly between an unmounted condition and a mounted condition. A quick mount/release mechanism cooperates between the proximal insert portion of the rotary valve assembly and the distal portion of the actuator housing to enable a releasable, quick operable mounting engagement of the rotary valve assembly to the actuator assembly, in the mounted condition, free of any threaded mounting structure.

### RELATED APPLICATIONS

This application claims priority under 35 U.S.C. §119(e) from co-pending U.S. Provisional Patent Application No. 62/102,722, filed Jan. 13, 2015, entitled “QUICK MOUNT/RELEASE, MICRO-FLUIDIC VALVE ASSEMBLY” which is incorporated by reference in its entirety.

### FIELD OF THE INVENTION

The present invention relates to multi-position, micro-fluidic valve assemblies in the field of Invitro Diagnostics (IVD) and analytical instruments, and more particularly relates to quick-mount, micro-fluidic valve assemblies

### BACKGROUND OF THE INVENTION

Rotary shear valve assemblies are commonly used in the HPLC analytical instrument market. These valve assemblies are characterized by relatively long life and high precision fluid delivery. Many rotary valve assemblies are typically mounted to actuator assemblies which control and drive the rotational position of the multi-position valve itself.

IDEX Health and Science, for example, has been manufacturing these multi-position, micro-fluidic valves and valve assemblies for at least a decade under the Rheodyne® brand. This began with the TitanHP™ valve line and was then improved with the TitanHT™ valve line. In these prior designs, the multi-position, rotary shear valve apparatus 20 includes the valve assembly 21 itself, as shown in FIGS. 1 and 2, which can be removed from an actuator assembly 22 for replacement and maintenance of the valve assembly.

In the TitanHP™ and TitanHT™ design, for instance, a threaded nut 23 was used to retain the valve assembly 21 inside the housing 25 of the actuator assembly 11. This assembly was very simplistic, and, in theory, the valve assembly 21 could be hand installed and removed without the use of tools. In practice, however, the threaded nut 23 could easily be over tightened making it difficult for tool-less removal of the valve when installed in certain instruments or lab arrangements. On the other end, the hand threaded nut could just as easily be under tightened and potentially come off and/or allow the valve to fall out of the actuator assembly 22 during use. Also, it has been found over the years that when these types of valves (TitanHP™ and TitanHT™) are exposed to vibration testing, it is possible for the nuts 23 to loosen during testing. This requires the nut to be tightened to a certain torque which may make removal of the nut by hand difficult.

Accordingly, it is desirable to provide a micro-fluidic valve assembly that can be easily and stably hand mounted to an actuator assembly, while at the same time provide reliable tool-less release therefrom.

### SUMMARY OF THE INVENTION

The present invention provides a quick-mount/release, multi-position, micro-fluidic valve system operably mounted to a drive assembly. The valve system includes an actuator assembly having an actuator housing with a proximal portion and a distal portion. The actuator housing further defines a through-chamber extending therethrough. The distal portion thereof has a circumferential interior wall distally terminating at a distal edge portion that defines an opening into a receiving cavity at a distal portion of the through-chamber. The actuator assembly further includes an actuator shaft rotationally disposed in the through-chamber for rotation about a shaft rotational axis. The actuator shaft includes a proximal end configured to couple to the drive assembly, and a distal end terminating in the receiving cavity. The valve assembly further includes a rotary valve assembly having a POD housing rotatable supporting a valve shaft. The valve shaft includes a proximal end portion extending proximally from the POD housing. A proximal insert portion of the POD housing is formed and dimensioned for sliding axial receipt in the receiving cavity of the actuator assembly between an unmounted condition, separated from the actuator housing, and a mounted condition. In the mounted condition, the insert portion is snugly engaged with the circumferential interior wall of actuator housing, and the proximal end portion of the valve shaft is clocked and operably engaged with the distal end of the actuator shaft. Finally, the valve system includes a quick mount/release mechanism cooperating between the proximal insert portion of the rotary valve assembly and the distal portion of the actuator housing to enable a releasable, quick operable mounting engagement of the rotary valve assembly to the actuator assembly, in the mounted condition, free of any threaded mounting structure.

Accordingly, the function and operation of the valve assembly, as far as the fashion by which it is generally installed into actuator housing and clocks to the actuator assembly are still similar, but the threaded nut device has been removed and replaced by a new quick mount/release mechanism. This new mechanism enables the valve assembly to be easily and stably hand mounted to the actuator assembly, while at the same time provide reliable tool-less release therefrom, and without the use any threaded nuts.

In one specific embodiment, the quick mount/release mechanism includes a housing first window disposed along the distal portion of the actuator housing, extending from an exterior wall of the actuator housing to the circumferential interior wall for communication into the receiving cavity; and a first clip assembly having a first button portion coupled to the insert portion of the POD housing for radial movement between a retracted position and an extended condition. The quick mount/release mechanism further includes a first biasing device that biases the first button portion radially outward toward the extended condition. When the first button portion is in the retracted position, the insert portion of the POD housing can be manually inserted into the interior wall of the actuator assembly such that the valve assembly is movable from the unmounted condition to the mounted condition. When the bottom portion is in the extended condition and the valve assembly is in the mounted condition, the button portion is sized and dimensioned to extend radially through the housing first window in a manner preventing axial separation during operation thereof.

In another specific embodiment, the quick mount/release mechanism further includes a housing second window disposed along the distal portion of the actuator housing at an orientation generally opposite the housing first window. The second window extends from the exterior wall of the actuator housing to the circumferential interior wall for communication into the receiving cavity. A second clip assembly is provided having a second button portion coupled to the insert portion of the POD housing at an orientation thereof generally opposite the first clip assembly for radial movement between a respective retracted position and a respective extended condition. Similarly, the quick mount/release mechanism further includes a second biasing device biasing the second button portion radially outward toward the extended condition. When the second button portion is in the respective retracted position, the insert portion of the POD housing can be manually inserted into the interior wall of the actuator assembly such that the valve assembly is movable from the unmounted condition to the mounted condition. Further, when the second bottom portion is in the extended condition and the valve assembly is in the mounted condition, the second button portion is sized and dimensioned to extend radially through the housing second window in a manner preventing axial separation during operation thereof.

In still another configuration, the quick-mount/release, multi-position, micro-fluidic valve system further includes an alignment device cooperating between the valve assembly and the actuator housing to assure aligned mounting therebetween in the mounting condition. The alignment device, in one specific embodiment, includes the first window and the corresponding first button portion having a transverse cross-section footprint different from that of the second window and corresponding second button portion. In yet another alignment configuration, the alignment device includes the first window and the corresponding first button being axially spaced along the rotational axis from that of the second window and corresponding second button portion.

The first and second biasing device, in another specific embodiment, biases the respective first button portion and the second button portion radially outward with a respective radial spring rate in the range of about 5 lbs/in to about 20 lbs/in.

In another specific embodiment, the first button portion and the second button portion each having a respective substantially planar, upper wall oriented generally perpendicular to the rotational axis. In the respective extended condition, the respective upper wall prevents movement of the valve assembly from the mounted condition toward the unmounted condition unless the first button portion and the second button portion, respectively, is moved from the extended condition toward the retracted condition.

In another specific configuration, the first button portion and the second button portion each having a steep, outwardly tapered bottom wall that intersects the respective upper wall.

Another configuration provides a generally semi-cylindrical first button portion and second button portion, each having a semi-circular transverse cross-sectional dimension. Each the first window and the second window are defined in part by respective upper interior edges that taper upwardly and inwardly. When the valve assembly is manually urged from the mounted condition toward the unmounted condition, contact of respective curvilinear upper walls of each the first button portion and the second button portion with the respective upper interior edges of the first window and the second window facilitates respective inward radial movement toward thereof from the extended condition toward the retracted condition.

The upwardly and inwardly taper of each upper interior edge of the respective first window and the second window is in the range of about 35° to about 55°.

In another specific embodiment, the quick mount/release mechanism includes a magnetic assembly having a magnet configured to magnetically mount the valve assembly and the actuator assembly in the mounted condition.

In one magnetic configuration, the distal edge portion of the POD housing is comprised of a ferrous material, and the magnet includes an annular ring magnet incorporated in the annular collar such that when the valve assembly is oriented in the mounted condition, the ring magnet and the ferrous material distal edge portion sufficiently magnetically cooperate to enable the releasable, quick operable mounting engagement of the rotary valve assembly to the actuator assembly, free of any threaded mounting structure.

The magnetic assembly includes a sleeve insert comprised of a ferrous material, and providing the ferrous material distal edge portion at a distal insert portion thereof. The distal insert portion formed and dimensioned for removable sliding receipt of the valve assembly to the mounted condition, and the sleeve insert having a proximal insert portion formed and dimensioned for press-fit receipt into the receiving cavity.

In still another specific magnetic assembly, the magnet is provided by one or more electromagnets powered by the valve assembly.

Another aspect of the present invention provides a bayonet style quick mount/release mechanism that includes a pair of opposed location pins mounted to the proximal insert portion of the POD housing. A pair of corresponding J-shaped slots are included that are defined by the distal portion of the actuator housing. Each J-shaped slot includes a respective nub portion formed and dimensioned to retain a respective location pin of the pair of location pins therein, when valve assembly is in the mounted condition.

In one specific embodiment, a spring device is coupled between the valve assembly and the actuator assembly, and configured to bias a respective location pin into a respective nub portion of the corresponding J-shaped slot, when the valve assembly is in the mounted condition.

In yet another configuration, one location pin of the pair of opposed location pins has a different diameter than that of the other location pin. Further, each J-shaped slot is dimensioned for receipt of a respective location pin for aligned mounting of the valve assembly to the actuator assembly in the mounted condition.

In still another aspect of the present invention, the quick release/mount mechanism includes a canted coil spring lock assembly having a canted coil spring mounted to the insert portion of the POD housing.

In one configuration, the insert portion of the POD housing defines an annular groove formed and dimensioned for receipt of at least an inner portion of the canted coil spring therein. The circumferential interior wall defines an annular channel strategically positioned thereon such that when the valve assembly is positioned at the mounted condition, relative to the actuator assembly, an outer portion of the canted coil spring is simultaneously received in the annular channel.

### BRIEF DESCRIPTION OF THE DRAWINGS

The assembly of the present invention has other objects and features of advantage which will be more readily apparent from the following description of the best mode of carrying out the invention and the appended claims, when taken in conjunction with the accompanying drawings, in which:

FIG. 1 is a top perspective view of a prior art micro-fluidic valve system with a conventional threaded nut.

FIG. 2 is an exploded, top perspective view of the prior art micro-fluidic valve system of FIG. 1.

FIG. 3 is a top perspective view of a micro-fluidic valve system with a quick release/mount mechanism constructed in accordance with the present invention, and in particular having a spring loaded lock design.

FIG. 4 is an exploded, top perspective view of the micro-fluidic valve system of FIG. 3.

FIG. 5 is an enlarged, side elevation view of a valve assembly of the micro-fluidic valve system of FIG. 3, showing the spring loaded lock design in an extended condition.

FIG. 6 is a side elevation view of a valve assembly of FIG. 5, showing the spring loaded lock design in a retracted condition.

FIG. 7 is an exploded, top perspective view of the micro-fluidic valve system of FIG. 3.

FIG. 8 is an exploded, rear perspective view of the micro-fluidic valve system of FIG. 3.

FIG. 9 is another exploded, top perspective view of the micro-fluidic valve system of FIG. 3.

FIG. 10 is a side elevation view, in cross-section, of the valve system of FIG. 3.

FIG. 11 is a fragmentary, enlarged, side elevation view, in cross-section, of the valve assembly of FIG. 10, showing the spring loaded lock design in the extended condition.

FIG. 12 is a fragmentary, enlarged, side elevation view, in cross-section, of the spring loaded lock design of the valve assembly of FIG. 11.

FIG. 13 is a diagram showing the chamfer angle of an upper interior edge for a housing windows 46 of an actuator assembly of the valve assembly of FIG. 11.

FIG. 14 is an enlarged, top perspective view of a POD housing of the valve assembly of FIG. 5.

FIG. 15 is a rear perspective view of a POD housing of FIG. 14.

FIG. 16 is a bottom perspective view of a POD housing of FIG. 14.

FIG. 17 is a top perspective view of the micro-fluidic valve system of FIG. 3, with an a alternative embodiment spring loaded lock design.

FIG. 18 is an exploded, top perspective view of the micro-fluidic valve system of

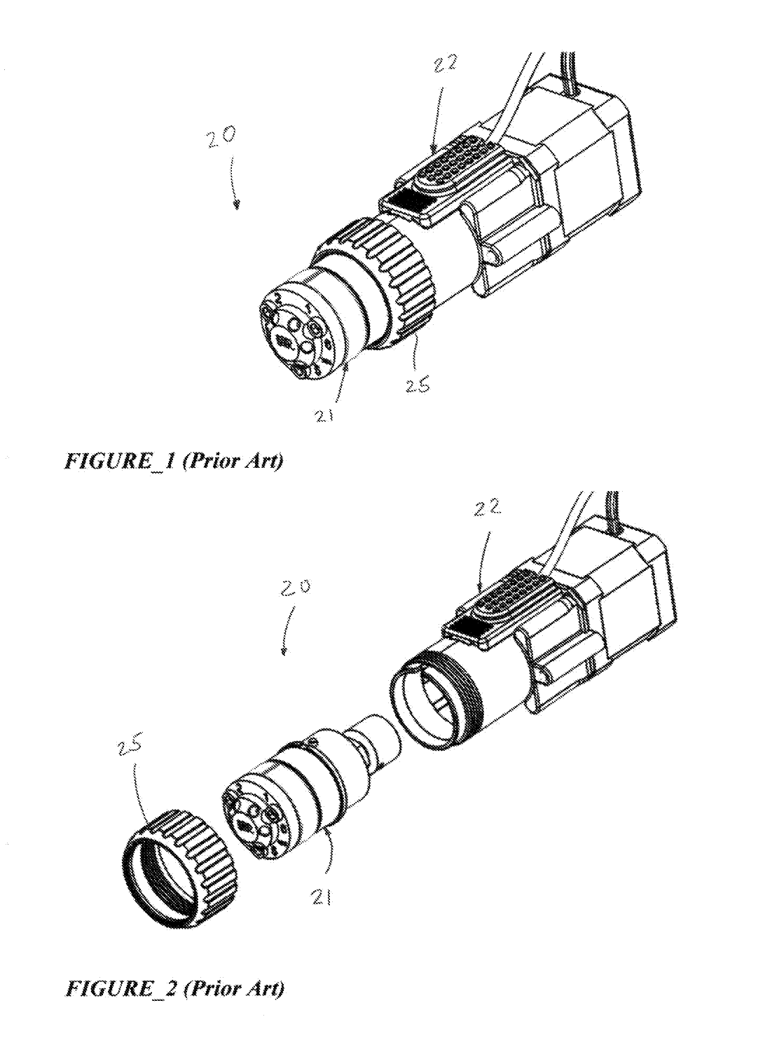

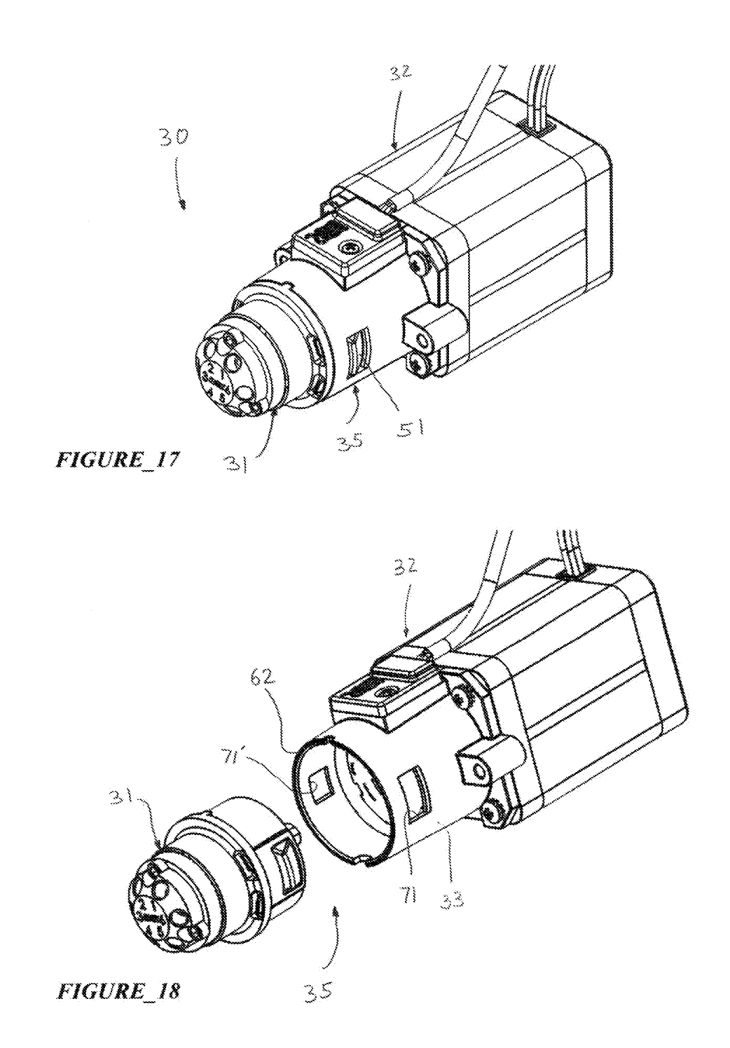

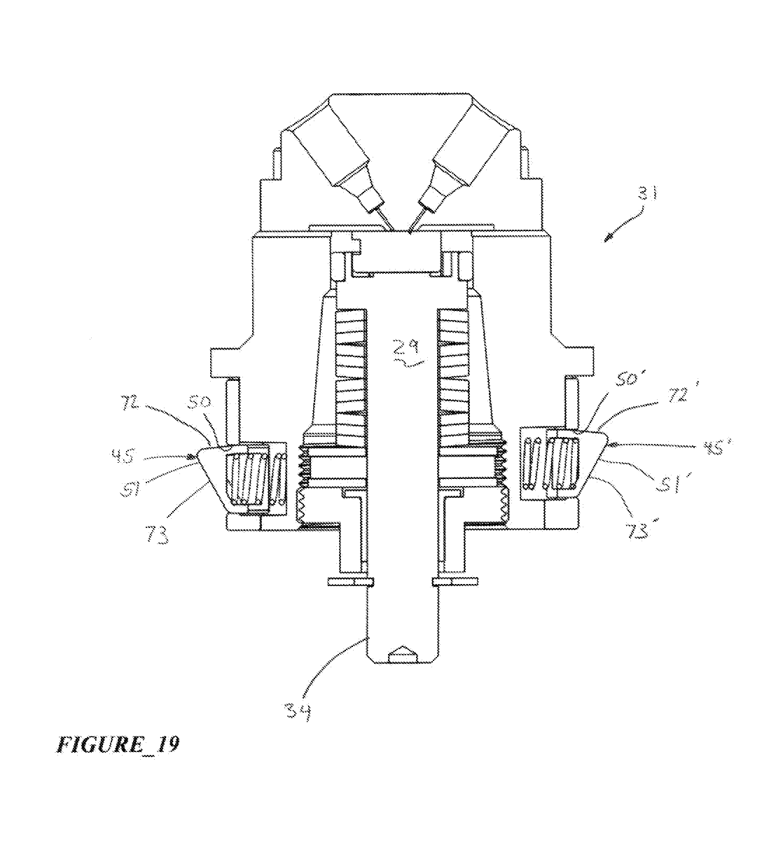

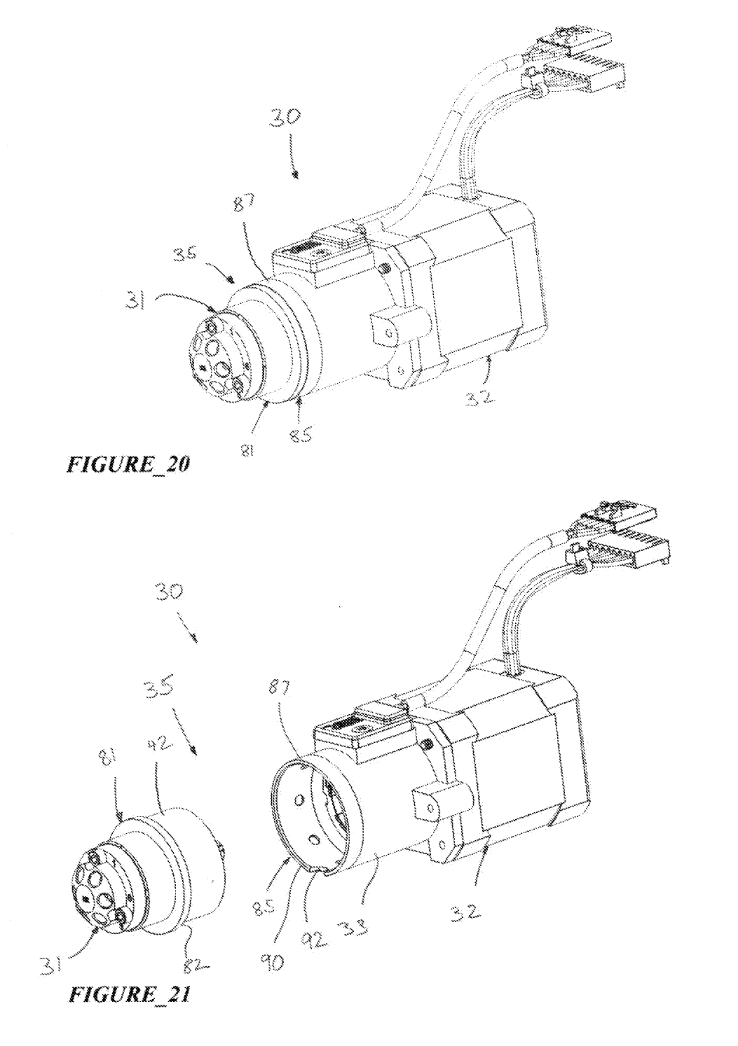

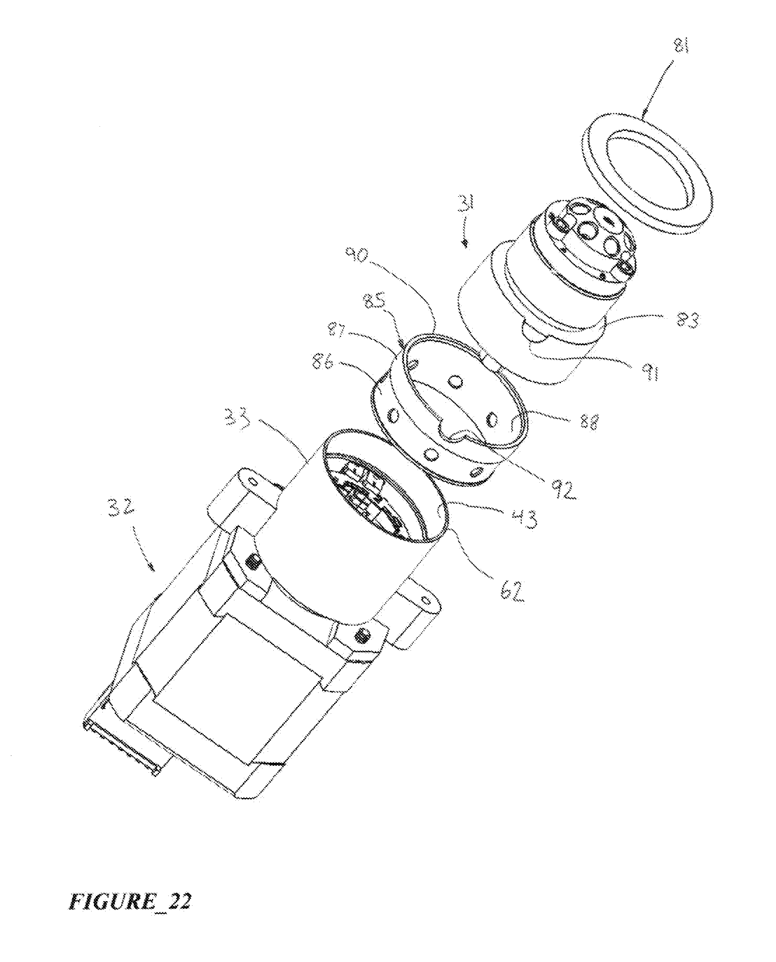

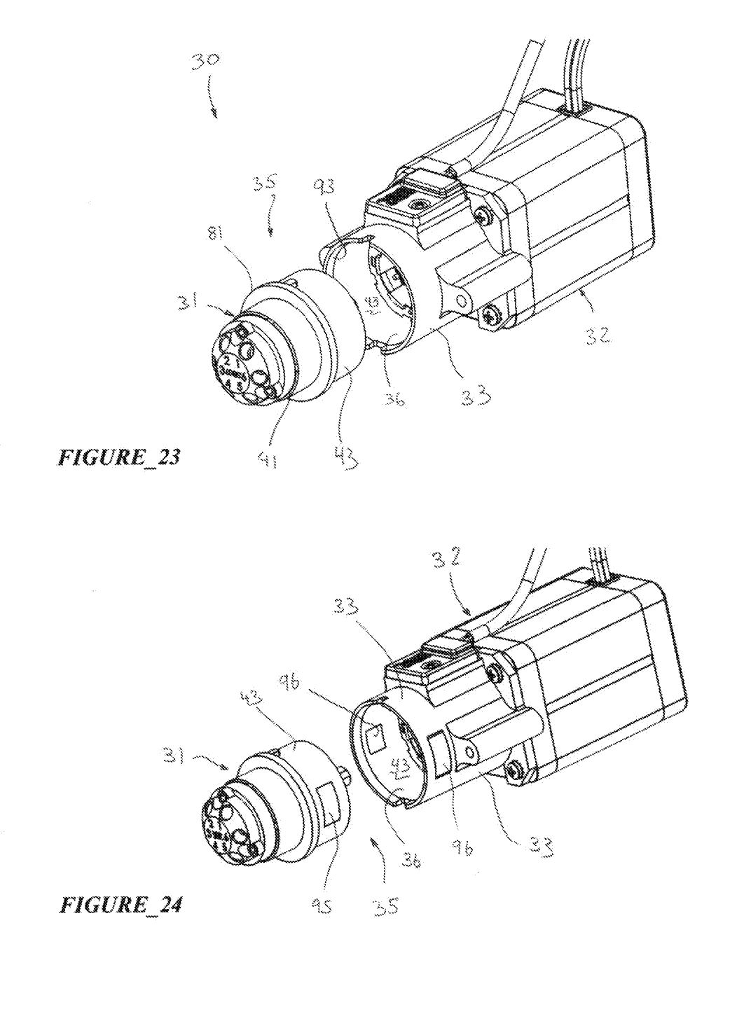

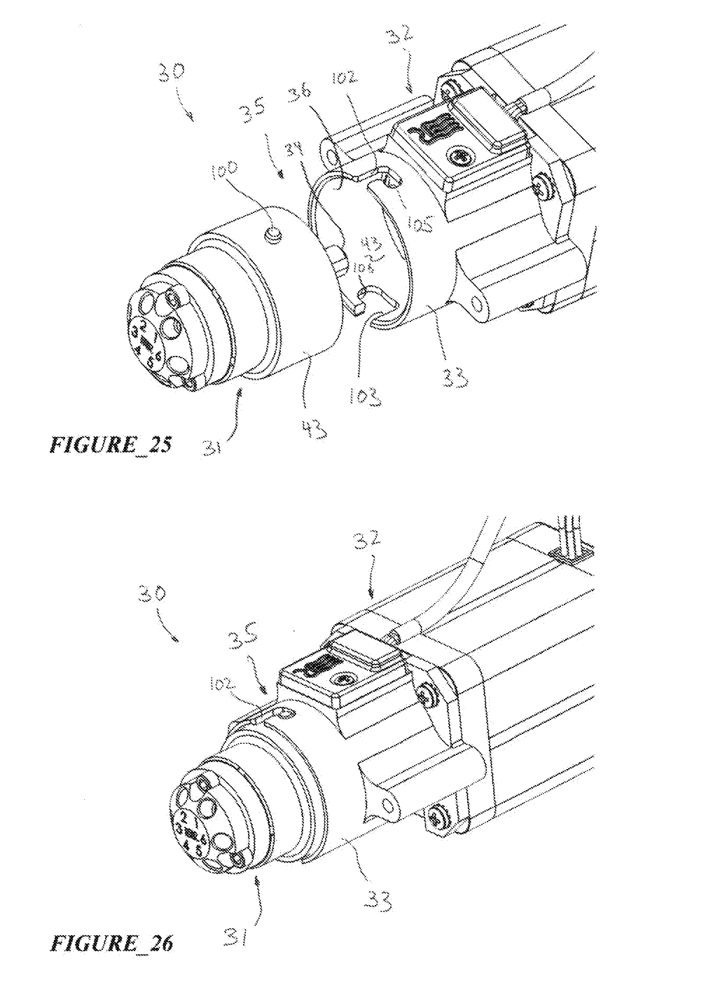

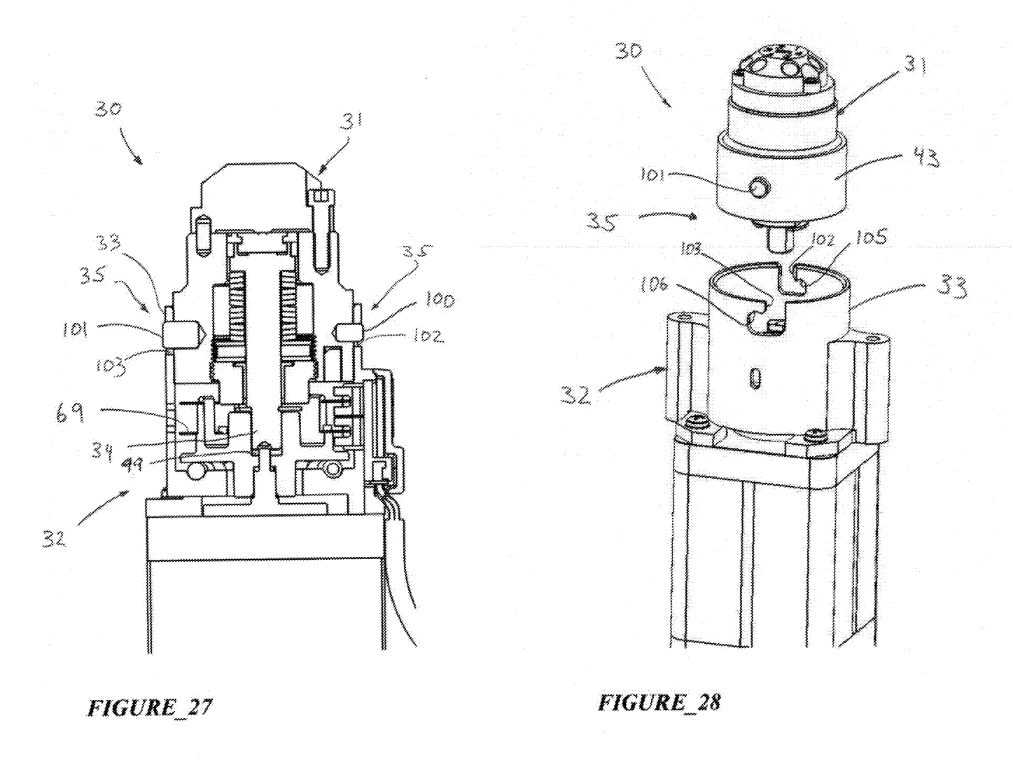

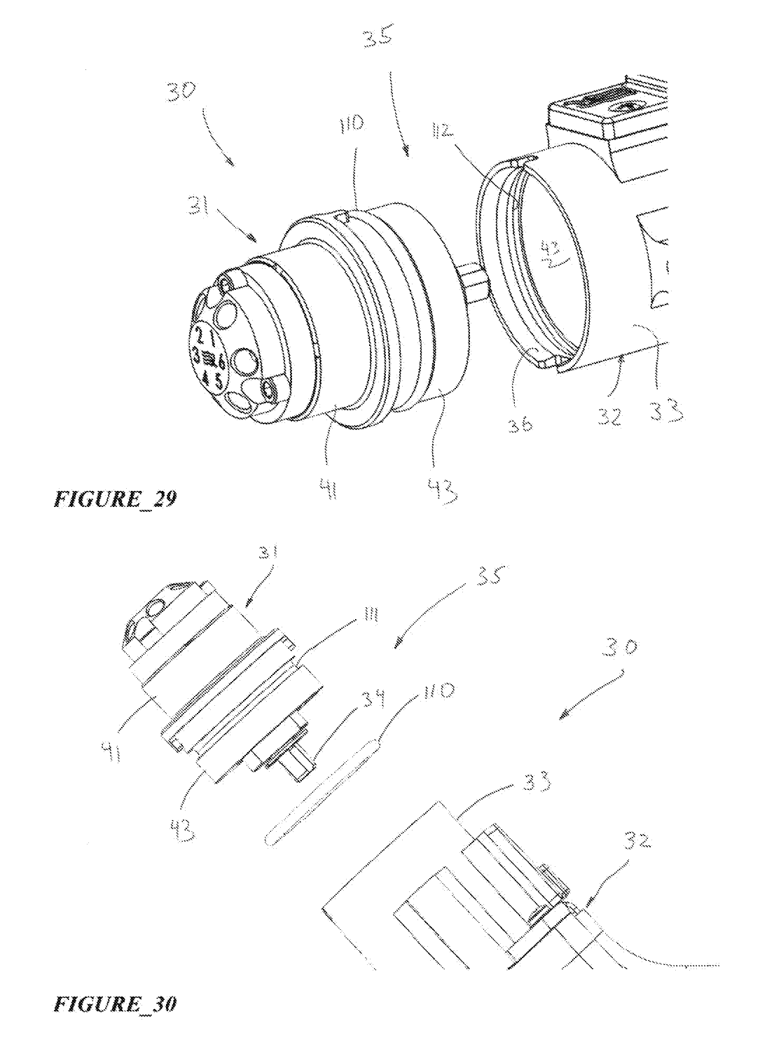

FIG. 17.

FIG. 19 is an enlarged, side elevation view, in cross-section, of the valve assembly of the micro-fluidic valve system of FIG. 17, showing the alternative embodiment spring loaded lock design in an extended condition.

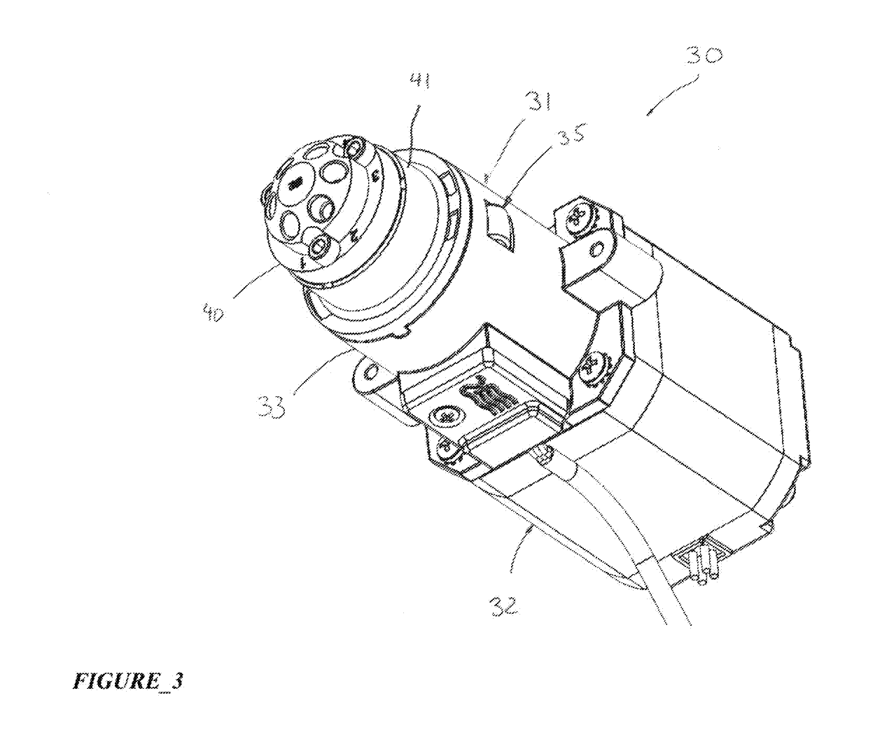

FIG. 20 is a top perspective view of the micro-fluidic valve system of FIG. 3, with an alternative embodiment magnetic lock quick release/mount mechanism.

FIG. 21 is an exploded, top perspective view of the alternative embodiment micro-fluidic valve assembly of FIG. 20

FIG. 22 is a further exploded, top perspective view of the alternative embodiment micro-fluidic valve assembly of FIG. 20

FIG. 23 is an exploded, top perspective view of an alternative embodiment magnetic lock release/mount mechanism of the micro-fluidic valve system of FIG. 20.

FIG. 24 is an exploded, top perspective view of yet another alternative embodiment magnetic lock release/mount mechanism of the micro-fluidic valve system of FIG. 20.

FIG. 25 is a exploded, top perspective view of the micro-fluidic valve system of FIG. 3, with an alternative embodiment bayonet style quick release/mount mechanism.

FIG. 26 is a top perspective view of the alternative embodiment micro-fluidic valve assembly of FIG. 25

FIG. 27 is a fragmentary, side elevation view, in cross-section, of the valve assembly of FIG. 25.

FIG. 28 is another exploded, top perspective view of the alternative embodiment micro-fluidic valve assembly of FIG. 25

FIG. 29 is a exploded, top perspective view of the micro-fluidic valve system of FIG. 3, with an alternative embodiment canted coil spring lock style quick release/mount mechanism.

FIG. 30 is another exploded, top perspective view of the alternative embodiment micro-fluidic valve assembly of FIG. 29

FIG. 31 is a fragmentary, side elevation view, in cross-section, of the valve assembly of FIG. 28.

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

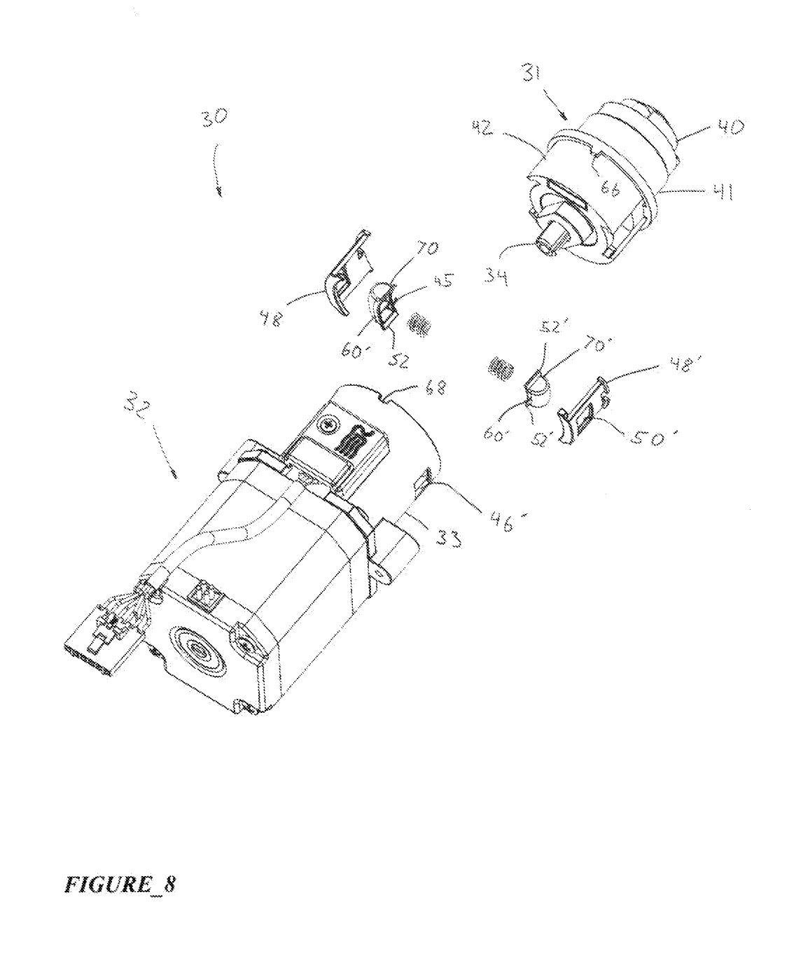

Turning now to FIGS. 3-10 (which illustrates an exemplary first embodiment of the present invention), a new multi-position, micro-fluidic valve system, generally designated 30, is provided that includes a quick mount/release shear face valve assembly 31 capable of being quick mounted directly into, and clocked with, an actuator assembly 32, via quick mount/release mechanism 35, without the use of a threaded nut. Accordingly, as will be described in greater detail below, the valve assembly 31 can be easily quick mounted/released to the actuator assembly 32 without the use of tools simply by manually axially pushing (mounting to) or axially pulling (release from) the valve assembly in to or out of the actuator assembly.

The actuator assembly 32, in general for all embodiments, includes an actuator housing 33 having a proximal portion and a distal portion, and defining a through-chamber extending therethrough. The distal portion of the housing 33 include a circumferential interior wall 36 distally terminating at a distal edge portion 62 that defines an opening into a receiving cavity 43 at a distal portion the of the through-chamber.

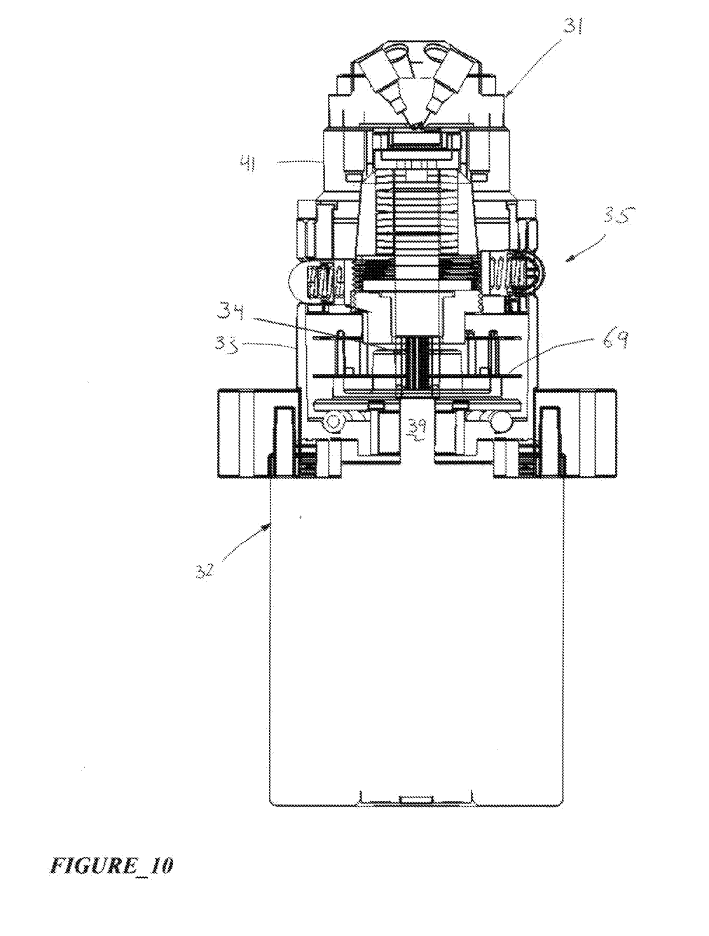

The micro-fluidic valve system 30 further includes an actuator shaft 39 rotationally disposed in the through-chamber for rotation about a shaft rotational axis (FIG. 10). The actuator shaft 39 has a proximal end configured to couple to a drive assembly, and a distal end terminating in the receiving cavity 43.

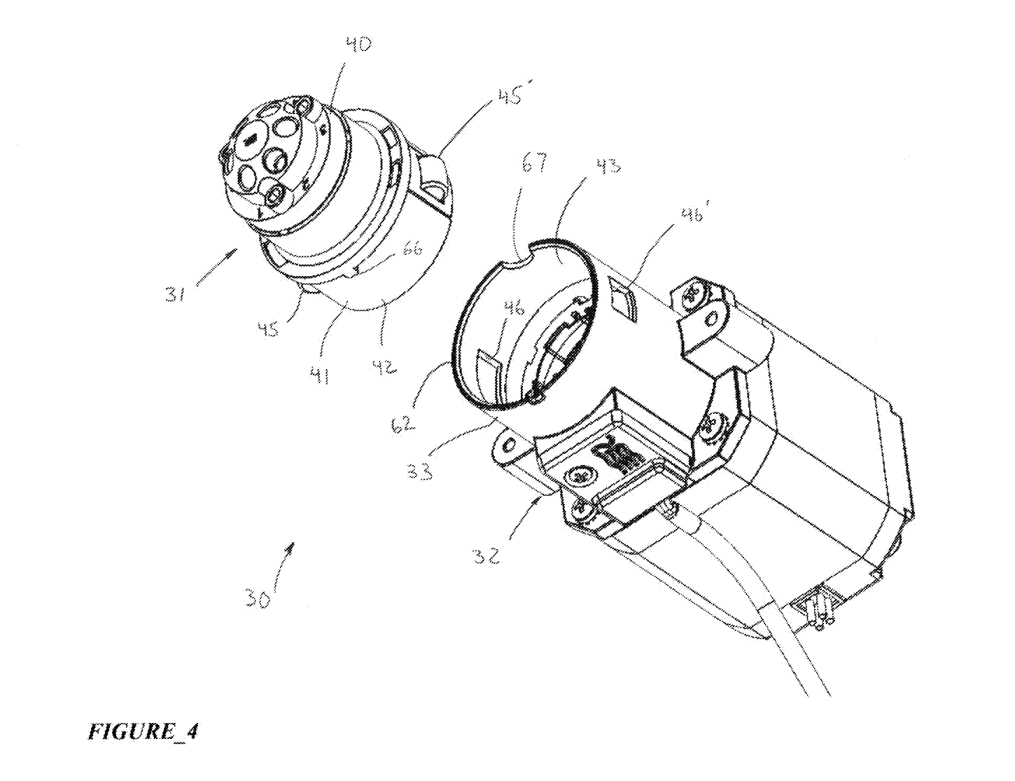

The rotary valve assembly 31 includes a POD housing 41 rotably supporting a valve shaft 29 having a proximal end portion extending proximally from the POD housing. The POD housing 41 includes a proximal insert portion 42 formed and dimensioned for sliding axial receipt in the receiving cavity 43 of the actuator assembly between an unmounted condition (FIG. 4), separated from the actuator housing 33, and a mounted condition (FIGS. 3 and 10). In the mounted condition, the insert portion 42 is snugly engaged with the circumferential interior wall 36 of actuator housing 32, and the proximal end portion of the valve shaft 29 is clocked and operably engaged with the distal end of the actuator shaft 39.

In accordance with the present invention, a quick mount/release mechanism 35 is provided that cooperates between the proximal insert portion 42 of the rotary valve assembly 31 and the distal portion of the actuator housing 33 to enable a releasable, quick operable mounting engagement of the rotary valve assembly to the actuator assembly, in the mounted condition (FIGS. 3 and 10), free of any threaded mounting structure.

Accordingly, a micro-fluidic valve assembly 31 is provided that includes a quick mount/release mechanism 35 that enables the valve assembly 31 to be easily and stably hand mounted to the actuator assembly 32, while at the same time provide reliable tool-less release there from, and without the use any threaded nuts.

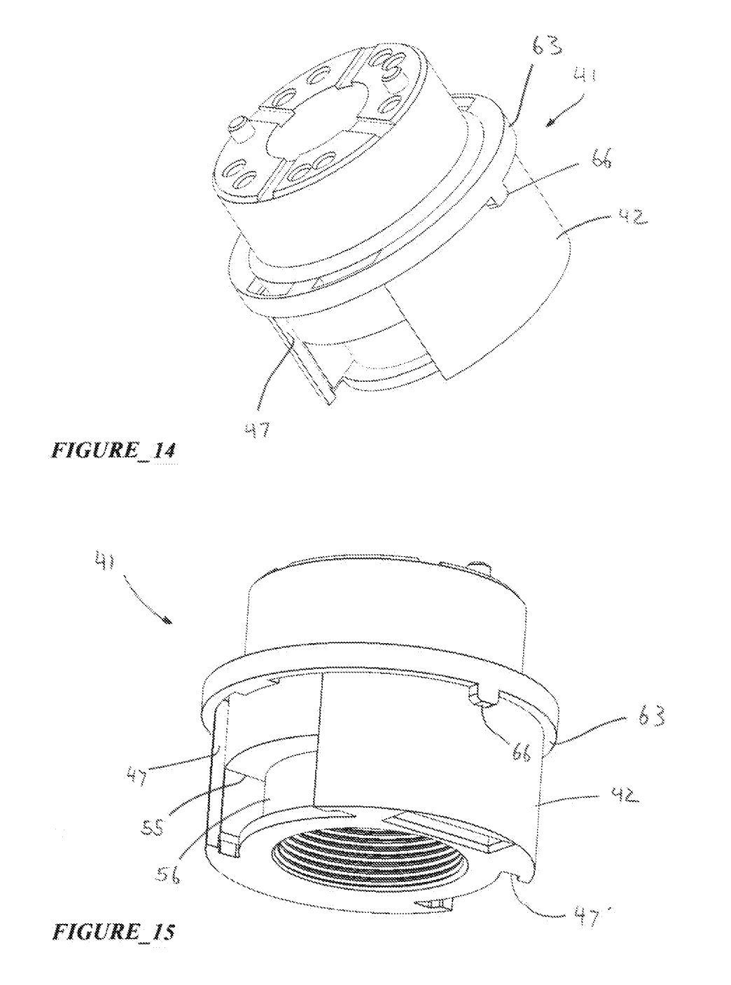

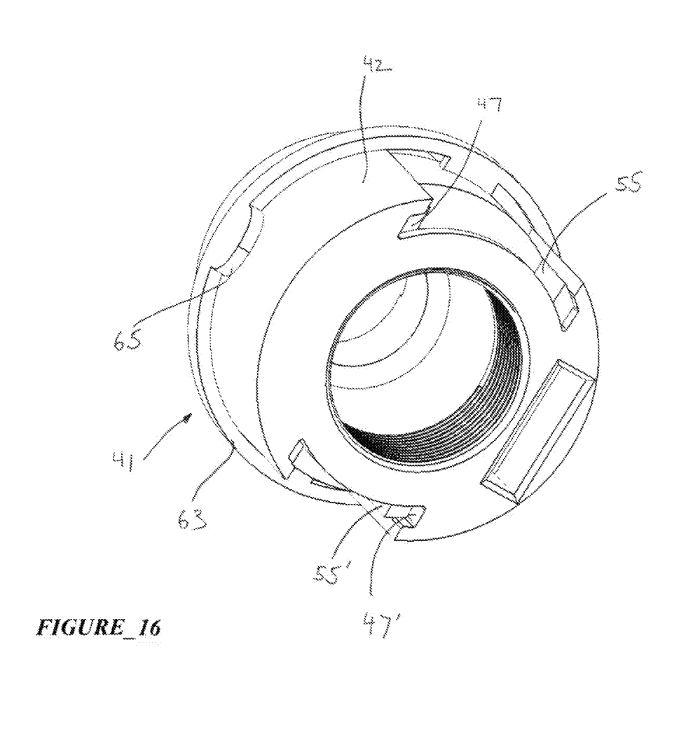

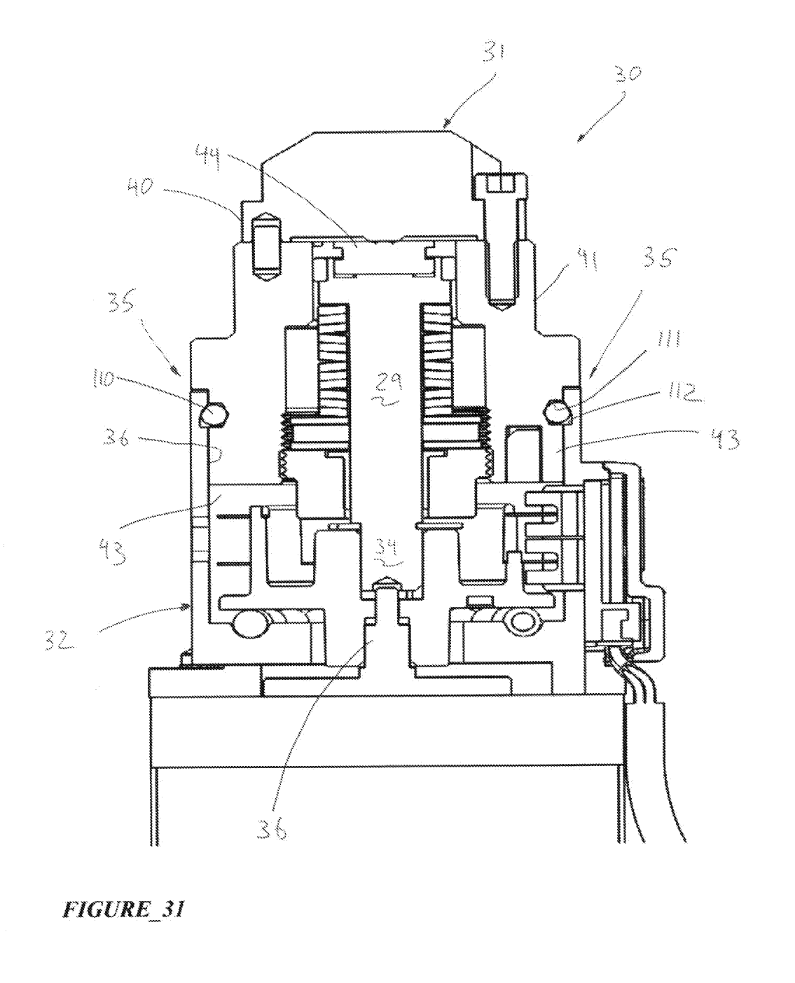

Briefly, there are four basic embodiments for the quick mount/release mechanism 35, which consists of a spring loaded lock design (FIGS. 3-19), a magnetic lock design (FIGS. 20-24), a bayonet lock design (FIGS. 25-28), and a canted coil spring lock design (FIGS. 29-31). Each embodiment allows the valve shaft 29 (not shown in every embodiment) to be aligned with the actuator shaft 39 (not shown in every embodiment), and permit the valve assembly 31 to be press-fit into the actuator housing 33 were it is finally located within the actuator assembly 32 (in the mounted condition) by a lower clocking pin 34 of the valve shaft 29, and one of the quick mount/release mechanism 35 designs, such as the spring loaded lock design (FIGS. 3-19), the magnetic lock design (FIGS. 20-24), the bayonet lock design (FIGS. 25-28), and the canted coil spring lock design (FIGS. 29-31). In all of these embodiments, as will be described below, the various quick mount/release mechanisms 35 can be varied in size and/or dimension, and are oriented at differing axial locations to prevent an incorrect installation within the valve actuator (i.e., one that is installed 180 Deg out of alignment).

During normal operation of these valve assemblies 31 when operationally mounted to the actuator assembly 32, it has been observed that a force of around 5 lbs was needed to prevent the valve POD from rising or moving within the actuator housing. A force range −10 lbs, therefore, is adequate to resist the eccentric forces, but low enough that the valve POD can be removed by hand with minimal effort. It will be appreciated, however, that these figures can vary depending upon the selected components applied.

Referring generally to the valve assembly 31 used in all quick mount/release embodiments, a stator device 40 and a rotor device 44 are included mounted to the valve POD housing 41 (FIGS. 10 and 14). The stator device 40 provides a stator face (not shown) that is compressed against a rotor face (not shown) of a rotor device 44 which is rotably mounted to a valve shaft 29, the clocking pin 34 of which extends distally there from. The valve POD housing 41 is preferably die-cast or machined, and includes an outer cylindrical-shaped insert portion 42 that is sized and dimensioned for snug, sliding axially receipt in a cylindrical receiving cavity 43 of the actuator housing 33 of the actuator assembly 32.

Referring now to the spring loaded lock design of FIGS. 3-19, the quick mount/release mechanism 35, in accordance with the present invention, includes a pair of opposed, moveable “clip” members 45, 45′ that are biased outwardly toward an extended condition (FIGS. 5, 11 and 12). Briefly, when the valve assembly 31 is aligned and slid into the receiving cavity 43, these clip members 45, 45′ engage a pair of strategically placed actuator housing windows 46, 46′ formed and dimensioned for receipts of the clip members 45, 45′ therethrough. Once the biased clip members 45, 45′ have moved sufficiently toward the extended condition, the valve assembly 31 will be sufficiently secured with the actuator assembly for operation thereof, without the use of tools or threaded nuts, while the clocking pin 34 aligns and engages with the drive mechanism and encoder components of the actuator assembly 32.

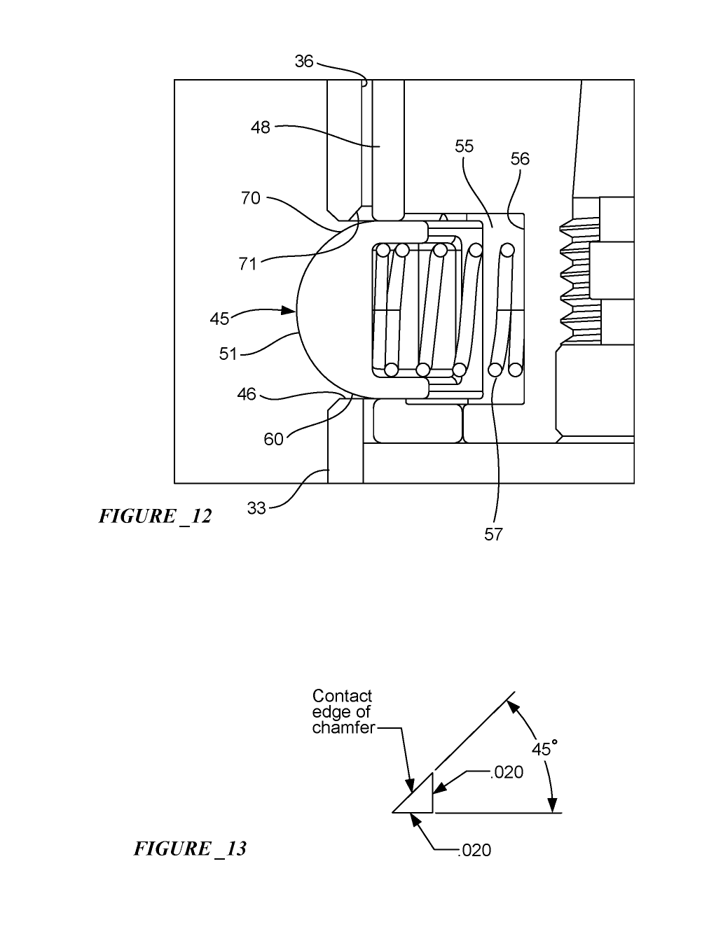

As best viewed in FIGS. 12 and 14-16, the valve POD housing 41 defines a pair of opposed outer facing sockets 47, 47′ which are formed and dimensioned for press-fit axial receipt of the corresponding clip retainers 48, 48′ therein. These clip retainers define retainer windows 50, 50′ that enable radial reciprocation of the corresponding clip members therethrough.

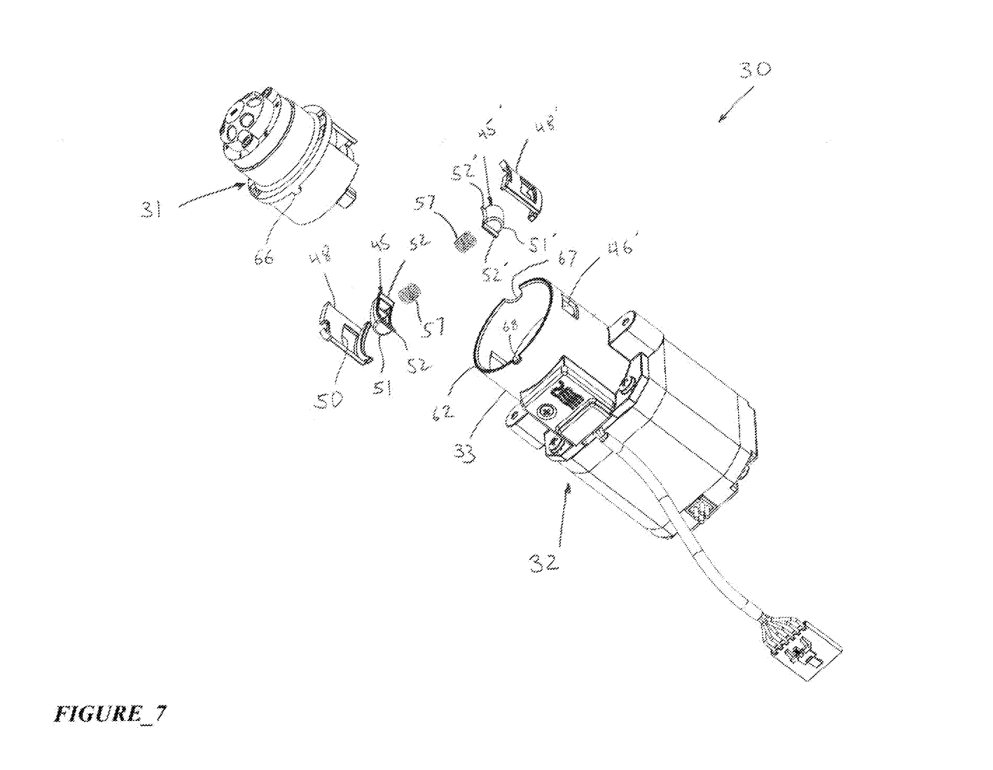

Each clip member 45, 45′ is preferably injection molded or die-cast, and includes a respective button portion 51, 51′ and corresponding winged portion 52, 52′ laterally extending outwardly from at least two opposed sides of the button portion (FIGS. 7-9). While the button portion 51, 51′ is sized to enable reciprocation radially through the corresponding retainer window 50, 50′, the winged portions 52, 52′ extend laterally beyond the corresponding retainer window 50, 50′, limiting the radial travel of the clip member 45, 45′ at the extended condition.

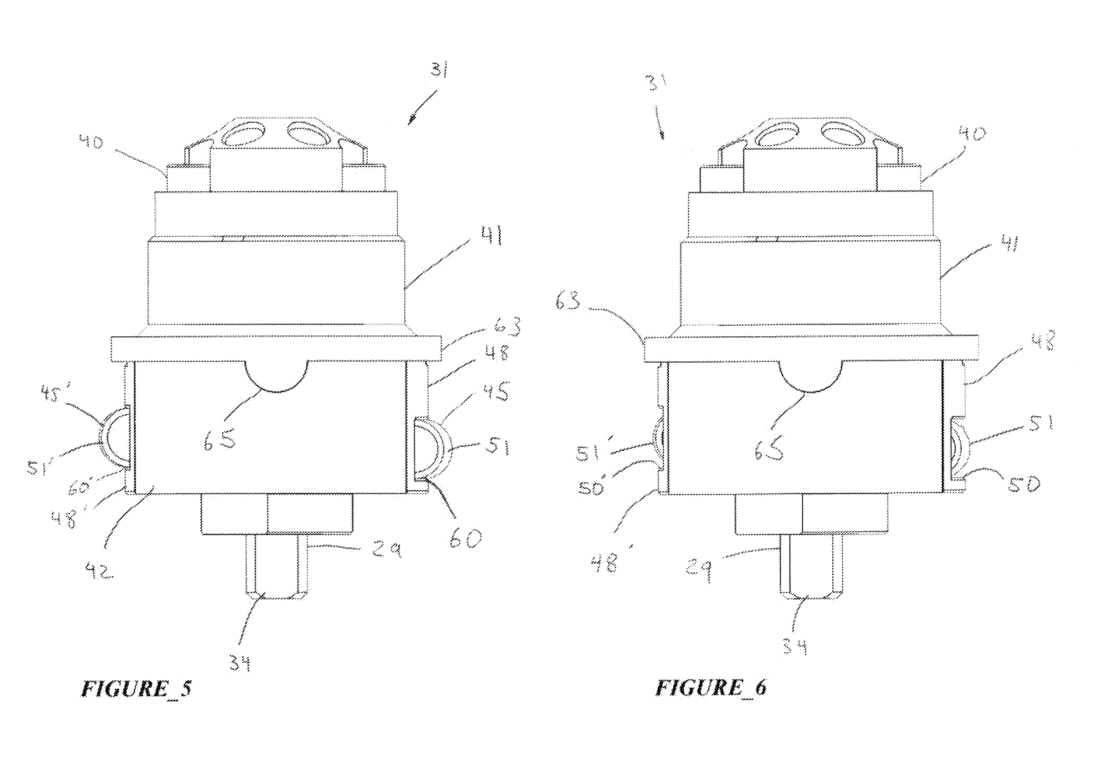

Each socket 47, 47′ of the POD housing 41 further defines a corresponding well 55, 55′ sufficient radially deep to enable each corresponding clip member 45, 45′ to reciprocate in a radial direction, relative to a longitudinal axis thereof, between a retracted condition (FIG. 6) and an extended condition (e.g., FIGS. 3-5). Each well 55, 55′ is partially defined by a back wall 56, 56′ formed for back support of a corresponding compression spring 57, 57′ disposed between the back wall and the respective clip member 45, 45′.

Each clip member 45, 45′ is further essentially hollow, enabling one end of each compression spring 57, 57′ to seat therein, and push off against, biasing the respective clip member 45, 45′ radially outwardly.

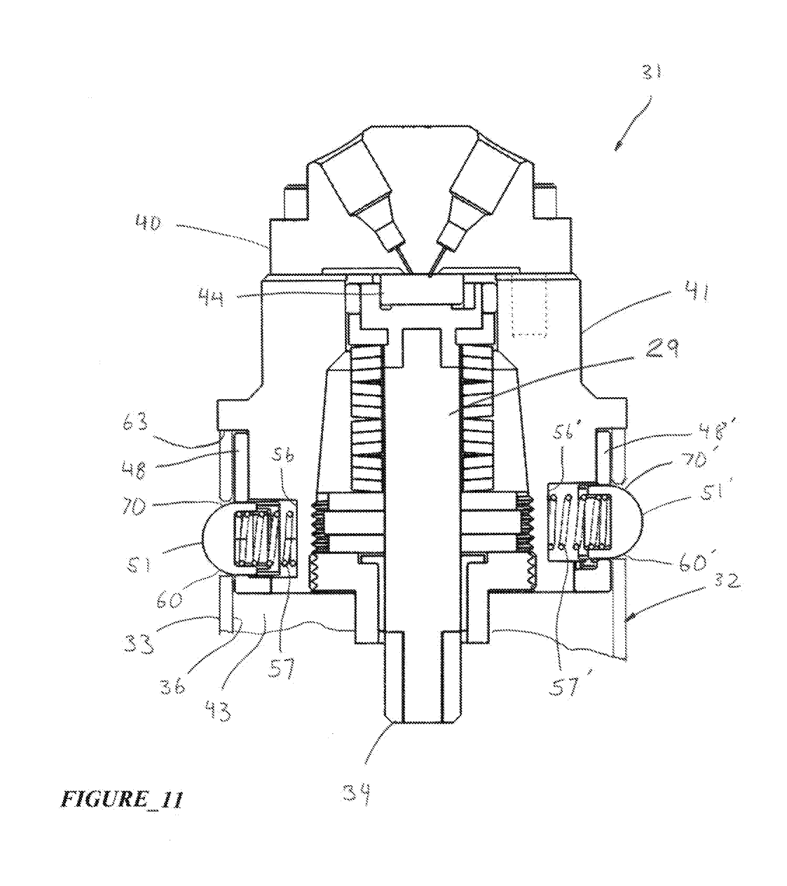

In accordance with the present invention, and as best shown in FIGS. 4 and 19, to prepare the valve assembly 31 for insertion into the actuator assembly 32, the valve POD housing is generally aligned therewith, as will be described better below. As the outer cylindrical-shaped insert portion 42 is axially inserted (manually) into the cylindrical receiving cavity 43 of the actuator housing 33, contact of the rounded bottom walls 60, 60′ (FIGS. 5 and 11) of the clip button portion 51, 51′ (or the ramped portion 73, 73′ of the embodiment of FIGS. 17-19) with a distal edge portion 62 of the actuator housing 33 causes the clip button portions to be urged radially inward toward the retracted condition (FIG. 6).

Once the apex of the button portions 51, 51′ are sufficiently retracted (i.e., essentially pushed radially inward so as to be generally flush with the outer cylindrical-shaped insert portion 42), the outer cylindrical-shaped insert portion of the valve assembly 31 can be further inserted into the receiving cavity 43. As the valve assembly 31 is pressed fully into the actuator assembly 32, the clip members 45, 45′ are recess into wells 55, 55′ that are die cast or machined into the valve housing. An annular collar 63 of the POD housing abuts the distal edge portion 62 of the actuator housing, preventing over-insertion of the valve assembly into the actuator receiving cavity. Upon radial and axial alignment of the retainer windows 50, 50′ with the corresponding actuator housing windows 46, 46′, the button portions 51, 51′ are allowed to pop-out there through to the extended condition, operationally retaining the valve assembly 31 to and against the actuator assembly 32 (FIGS. 3 and 5).

In accordance with the present invention, there are several alignment structures to assure the valve assembly 31 is properly aligned and installed correctly into the actuator assembly 32. Moreover, one or more of these alignment structures further function to prevent inadvertent rotation of the entire valve assembly within the receiving cavity 43 of the actuator housing 33.

In one example, as best shown in FIGS. 4-9, protruding proximally or downwardly from the collar 63 is at least one key device 65. Preferably, there are two opposed key devices 65, 66, each being differently shaped and differently sized from one another. In this embodiment, by way of example, one key device 66 is rectangular, while the opposed key device 65 is semicircular and larger.

To accommodate these key devices 65, 66, the distal edge portion 62 of the actuator housing 33 defines strategically positioned and aligned key receptacles 67, 68 formed and dimensioned for axial receipt of the corresponding key devices therein. While these key devices 65, 66 function to prevent rotation relative rotations between the valve assembly 31 and the actuator assembly, these keys primarily function to align the opposed retainer windows 50, 50′ with the corresponding actuator housing windows 46, 46′. Hence, the key devices in the POD housing ensure that the POD housing is installed correctly within the actuator housing.

Alternatively, the two key devices 65, 66 and corresponding aligned key receptacles 67, 68 can be radially slightly off-set, so as not to be exactly 180° apart. Such a radial off-set would further assure only relative one alignment and orientations between the valve assembly 31 and the actuator assembly 32.

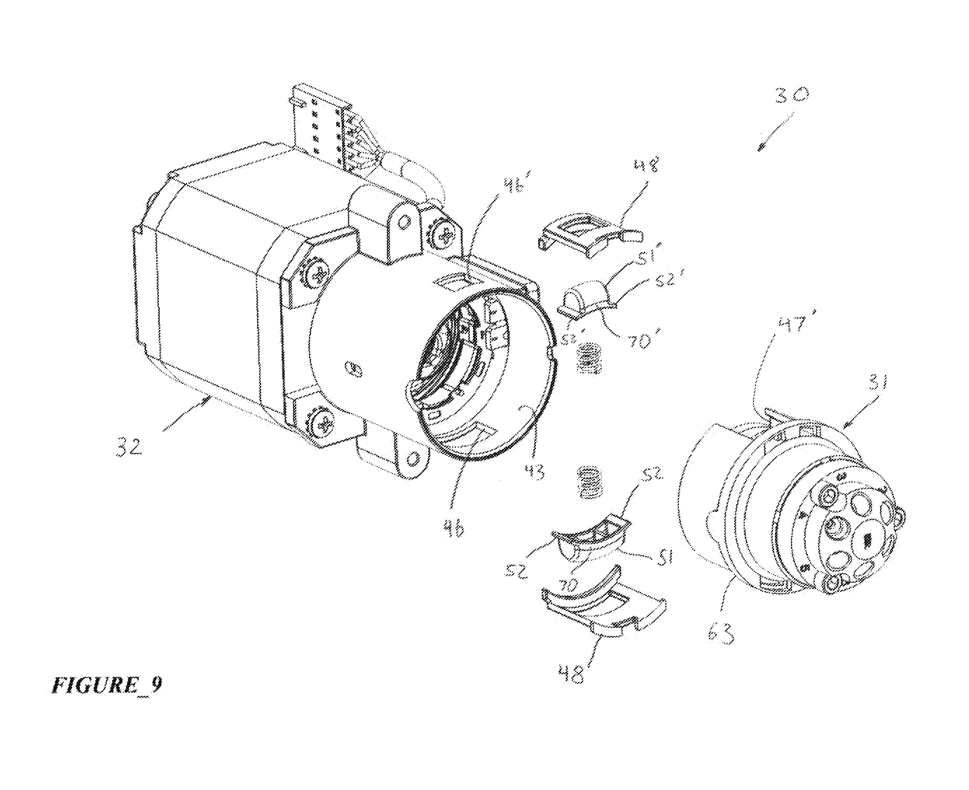

In a similar manner, the clip members 45, 45′ and corresponding retainer windows 50, 50′ and actuator housing windows 46, 46′ can be differently sized, radially off-set and longitudinally or axially off-set to assure align mating between the valve assembly 31 and the actuator assembly 32 (FIGS. 9, 11 and 12). By way of example, button portion 51 and its corresponding retainer and actuator housing windows 50, 46 are larger than that of button portion 51′ and its corresponding windows 50′, 46′, thus permitting only one way of aligned receipt. As another example, the larger clip member 45, and corresponding retainer and actuator housing windows 50, 46 are varied axially (e.g., offset 0.05″) relative to the smaller clip member 45, and corresponding retainer and actuator housing windows 50′, 46′, along the longitudinal and/or rotational axis of the valve assembly 31 and the actuator assembly 32. By placing the larger clip member 45, and the corresponding retainer and the actuator housing windows 50, 46 more proximally or axially closer to the actuator assembly than that of the smaller clip member 45′, this axial off-set assures that in no event will even the smaller clip member be inadvertently installed in the larger actuator housing window 46.

To release the valve assembly 31 from the actuator assembly 32, in one embodiment, a tool device (not shown) can be applied to facilitate depression of the button portions 51, 51′ to compress the compression springs 57, 57′ simultaneously to enable the user to easily pull the valve assembly out of the actuator housing receiving cavity. In another specific embodiment, it is desirable to not only provide tool-less assembly, but also tool-less disassembly. That is, provide the ability to remove the valve assembly 31 from the actuator assembly 32 by manually pulling the valve assembly in a direction axially away from the actuator assembly.

Several factors cooperate to determine the retention ability of the clip members 45, 45′ within the respective retainer and actuator windows, with the primary factor relating to the spring force exerted radially outward on their respective clip members 45, 45′. Depending upon the retention force desired to retain the valve assembly 31 operably mounted to the actuator assembly 32, the rates of the compression springs 57, 57′ can be selected. Other factors include the shape and slope of the upper walls 70, 70′ of the button portions 51, 51′, as well as the slope and taper of the respective upper interior edges 71, 71′ (essentially chamfers) of the corresponding housing window 46, 46′. This is advantageous in that the taper of the respective interior edges 71, 71′ allow the user to “pull out” the valve without the use of tools or manually pressing inward the buttons/clips first (FIGS. 11 and 12).

For example, since the forces applied to the valve assembly 31 are generally axial and generally perpendicular to the direction of compression for each compression spring 57, 57′, the more horizontal the upper walls 70, 70′ of the button portions 51, 51′ and the upper interior edges 71, 71′ of the actuator housing 46, 46′, the greater the force necessary to facilitate such compression. Hence, at least some taper of at least one of these surfaces is necessary to commence inward radial movement of the clip members 45, 45′.

In one preferred embodiment, using compression springs with a rate of about 5 lbs/in to about 20 lbs/in, and more preferably about 10 lbs/in to about 15 lbs/in, the taper of the upper walls 70, 70′ of the button portion 51, 51′ to be in the range of about 75 Degrees to about 90 Degrees, while the taper of the upper interior edges (or interior chamfers) 71, 71′ of the housing windows 46, 46′ to be in the range of about 35 Deg. to about 55 Deg (e.g., FIG. 13).

In another specific embodiment, as shown in the embodiment of FIGS. 17-19, the shape of the button portions 51, 51′ are altered, having generally horizontal upper walls 72, 72′, as well as steep, outwardly tapered bottom walls 73, 73′ that intersects the corresponding upper wall. Accordingly, in this configuration, the depression of the button portions 51, 51′ is significantly aided as the valve assembly 31 is inserted into receiving cavity 43 of the actuator housing 33.

During insertion, the steeply tapered bottom walls 73, 73′ contact the distal edge portion 62 of the actuator housing 33, slideably forcing the clip members 45, 45′ radially inward. In contrast, the relatively horizontal upper walls 72, 72′ essentially prevent depression due to contact with the upper edges 71, 71′ of the actuator housing windows, and thus would require a depression tool in order to remove the valve assembly 31.

In another aspect of the present invention, turning now to FIGS. 20-25, the quick mount/release mechanism 35 is in the form of a magnetic locking design which also enables tool-less assembly and disassembly of the valve assembly 31 to and from the actuator assembly 32. Accordingly, the magnetic locking design is afforded the same tool-free assembly benefits that the spring loaded lock embodiment provides.

In one particular embodiment, the POD housing 41 of the valve assembly 31, as best illustrated in FIGS. 20-22, includes a ring magnet 81 that cooperates the valve POD housing 41 to create an annular collar portion 82, similar to that of the previous embodiment. This ring magnet 81 is sized and dimensioned to seat atop an annular shoulder portion 83 of outer cylindrical-shaped insert portion 42 of the POD housing 41. This ring magnet 81 is preferably either press-fit or die-cast into the POD housing 41 (as shown in FIG. 22), although other conventional means for fastening apply.

On the actuator assembly side in this embodiment, the magnetic lock, quick mount/release mechanism 35 includes a ferrous annular sleeve insert 85 mountable to the actuator housing which in turn provides a magnetic connection to the ring magnet 81. The sleeve insert 85 is preferably comprised of a ferrous material which of course is magnetically reactive to the ring magnet. This sleeve insert 85 can similarly be die-cast with the actuator housing 33 or is sized and dimensioned for snug, sliding axially receipt in the cylindrical receiving cavity 43 of the actuator housing of the actuator assembly 32.

FIGS. 21 and 22 best illustrate that the sleeve insert 85 includes a proximal insert ring portion 86 and a distal seat ring portion 87. The insert ring portion 86 is formed and dimensioned for receipt in the cylindrical receiving cavity 43 in a manner such that the seat ring portion 87 is secured and supported atop the distal edge portion 62 of the actuator housing 33.

The cylindrical interior wall 88 of the insert sleeve is formed and dimensioned for sliding receipt of the insert portion 42 of the POD housing 41. Accordingly, referring to FIGS. 21 and 22, the POD housing insert portion is slidingly inserted into the sleeve insert 85 until annular collar portion 82 of the ring magnet 81 magnetically seats against a distal annular edge 90 of the sleeve insert 85, magnetically coupling the valve assembly 31 to the actuator assembly 32 for operation thereof.

Depending on the strength of the ring magnet 81 selected, the magnetic field may be enough to operably retain the valve assembly, while not being so stout as to be too difficult to manually remove. In the preferred form, to assure operational utility, a ring magnet generating a magnetic force in the range of about 5 lbs force to about 15 lbs force is selected.

Similar to the previous embodiment, to assure proper alignment, at least one key device such as the semi-circular key device 91 protruding downwardly from the annular shoulder portion 83 of the outer cylindrical-shaped insert portion 42 of the POD housing 41. This key device 91 is strategically positioned and formed for axial receive in aligned key receptacle 92, ensuring that the POD housing is properly aligned with the actuator housing.

In another magnetic locking concept, attention is now directed to the embodiment of FIG. 23 where a ferrous band 93 or the like is mounted to the interior wall 36 of the receiving cavity 43. This embodiment eliminates the use of the sleeve insert 85 that is required in the embodiment of FIGS. 20-22.

Referring now to FIG. 24, another alternative embodiment magnetic lock, quick mount/release mechanism 35 is shown, wherein where the magnets are placed on the insert portion 42 of the valve assembly at the valve inserts 95 where the spring loaded clip members of the embodiments of FIGS. 3-19 were placed, and the corresponding windows in the actuator housing 33 are replaced by actuator inserts 96 composed of a ferrous material. The valve assembly 31 can be installed in a manner similar to the spring loaded design, but this concept does not need a special tool to remove the valve from the actuator. Depending on the strength of the magnet selected, the magnetic field may be enough to operably retain the valve assembly, while not being so stout as to be too difficult to manually remove.

This magnetic insert concept can be further developed by using electromagnets to magnetically retain the valve assembly 31 in the actuator assembly 32. In one configuration, the electromagnets are placed inside the actuator housing 33 where power is available, such as at the location of the actuator inserts 96 in FIG. 24. When the valve assembly is powered on, the electromagnets would be energized, rendering the operational valve assembly very difficult to remove. When the valve assembly is powered off, the electromagnets would yield a low to no magnetic field so that the valve assembly can be removed and maintained. This could be automatically triggered by the used of RFID in the valve or by a Hall Effect sensor sensing the presence of the valve.

In yet another aspect of the present invention, the quick mount/release mechanism 35 is provided by a bayonet-style lock device, as best shown in FIGS. 25-28. In this embodiment, the mechanism includes an opposed pair of location pin members 100, 101 protruding radially outward from the insert portion 42 of the valve assembly 31. These opposed location pins 100, 101 are press-fit into, or mounted on, the insert portion of the valve housing. They are configured to be transversely received in corresponding J-shaped slots 102, 103, the slots of which initially extend longitudinally downwardly from the distal edge portion 62 of the actuator housing 33. The respective slots 102, 103 extend through the exterior wall of the distal portion of the actuator housing 33, and into the receiving cavity 43. Each J-shaped slot 102, 103 includes a corresponding end nub portion 105, 106 sized and dimensioned to retain the respective location pin 100, 101 therein when the valve assembly is rotated clockwise, relative to the actuator assembly, to retain and position the valve assembly.

The longitudinal length of the respective pins 100, 101 (i.e., radial length relative to the rotational axis of the valve assembly) must be of a sufficient length to navigate the wall thickness of the actuator housing 33. The two location pins 100, 101 are preferably different diameters so that the valve can be located within the actuator housing correctly (cannot be installed 180 Deg out of position). Similarly, the corresponding J-shaped slots 102, 103 within the actuator housing 33 are sized differently as well to receive and accept the correct size of location pin.

Similar to the other concepts, in the mounted condition, the lower clocking pin 34 of the valve shaft 29 engages the actuator shaft/encoder spool 69 before the bayonet location pins 100, 101 are fully seated in the corresponding nub portions 105, 106. This two-stage engagement allows the valve POD to be turned into position without having the valve POD shaft and encoder shafts aligned prior to installation of the POD within the actuator. This is advantageous to the end user since the valve assembly 31 can be installed within the actuator assembly 32 blindly.

In order for this design to function properly, the valve assembly 31 must lock into position in the bayonet keyways. The valve is pressed into the keyway at the end of its engagement and is resisted by an elastomeric or “spring” device 99 that is located within the actuator shaft/encoder spool. This elastomeric or “spring” device biases the valve assembly 31 axially away from the actuator assembly 32. Accordingly, once a lower clocking pin 34 of the valve shaft 29 contact with this “spring” device, the operator must overcome the spring force to further push the location pin 100, 101 downwardly into engagement with the corresponding bayonet keyways or J-shaped slots 102, 103 of the actuator housing. As the pins bottom out in the corresponding slots, the valve assembly 31 can be “spun” clockwise to move the pins into the “locked” position, and placing the valve assembly in the mounted condition.

The spring force provided by the elastomer or spring will push or bias the valve assembly axially away from the actuator assembly, and “pop” it into is final position. This positions the respective location pins 100, 101 in the corresponding nub portions 105, 106 of the J-shaped slots 102, 103 for retainment therein. The force required to “lock” the valve into position is about 8-10 lbs. For the embodiment shown, this force range is needed in order to resist eccentric forces that are caused by misalignment and “out of concentric” conditions that have been observed between the valve shaft and encoder spool/actuator shaft. A force of 5lbs has been observed as necessary to prevent the valve POD from rising or moving within the actuator housing. A force range of 8-10 lbs is adequate to resist the eccentric forces, but low enough that the valve POD can be removed by hand with minimal effort.

Referring now to FIGS. 29-31, the last embodiment of the quick mount/release mechanism 35 is provided by a canted coil spring lock design for latching, locking, and holding applications such as the BAL SPRING™ by BAL SEAL®. In this canted coil spring lock design a circular canted coil spring 110 is disposed inside an annular groove 111 extending radially around the insert portion 42 of the valve assembly 31. Relative to the diameter of the canted coil spring 110, the depth of the annular groove 111 is such that the inner portions of the annular shaped canted coil spring 110 are received in the annular groove while extend the outer portions thereof extend radially outward from and past the cylindrical exterior wall of the insert portion 42 of the valve POD housing 41.

In accordance with these canted coil spring lock designs, the canted coil spring 110 can be compressed and forced further into the annular groove 111 so as to be flush with the cylindrical exterior wall of the insert portion 42. This allows the valve assembly 31 to be operationally mounted to the actuator assembly 32, from the unmounted condition (FIGS. 29 and 30) to the mounted condition (FIG. 31). Employing the key and alignment mechanisms previously discussed, the valve POD housing 41 can be aligned with the actuator housing 33, and the valve shaft 29 can be clocked and operably engaged with the actuator shaft 39.

To facilitate retainment of the valve assembly 31 to the actuator assembly 32 in the mounted condition, for this canted coil spring lock design of the quick mount/release mechanism 35, the interior wall 36 of the actuator housing 33 includes an annular channel 112. This channel is sized and dimensioned, and is strategically positioned axially along the interior wall such that the annular channel 112 cooperates with the annular groove 111 of the valve assembly insert portion 42 to simultaneously receive the canted coil spring. That is, in the mounted condition, the inner portion of the canted coil spring 110 is received in the valve annular groove 111 while the outer portion of the spring 110 is simultaneously received in the actuator housing annular channel 112, retaining the valve assembly to the actuator assembly.

The interaction between the actuator annular channel 112 and the canted coil spring 110 causes the POD housing 41 to be held within the actuator housing 33. The design of the collective annular groove 111/annular channel 112 (in the mounted condition) and the canted coil spring 110 designed allow the designer the ability to customize the fit based on the force needed to install and remove the valve POD. Similarly to the other designs, a removal force of 8-10 lbs is specified to account for eccentric forces moving the valve POD within the actuator due to misalignments between the valve shaft and actuator shaft. With this design, the install force can be different from the removal force, and is preferably lower to ease installation.

In addition, the present invention can be applied to any and all removable rotary shear valves used in any industry to provide a thread-less valve connection to an actuator assembly. This includes any applications (e.g., AI, IVD, etc) were a shear valve is used. The present invention can also be applied to any and all HPLC/IVD Instrument platforms/designs such as those provided by IDEX Health and Science.

All the previous quick mount/release mechanisms 35 can be located on either the valve POD side or the actuator housing side. With respect to the magnetic design, electro magnets can be applied to mount the valve assembly to the actuator assembly as well. Such electro magnets can be energized when the valve is powered on so that the valve cannot be removed during operation, but can be easily removed when powered off.

Furthermore, while the present invention has been described in connection with the preferred form of practicing it and modifications thereto, those of ordinary skill in the art will understand that many other modifications can be made thereto within the scope of the claims that follow. Accordingly, it is not intended that the scope of the invention in any way be limited by the above description, but instead be determined entirely by reference to the claims that follow.

What is claimed is:

1. A quick-mount/release, multi-position, micro-fluidic valve system operably mounted to a drive assembly, said valve system comprising:
an actuator assembly including;
an actuator housing having a proximal portion and a distal portion, and defining a through-chamber extending therethrough, said distal portion having a circumferential interior wall distally terminating at a distal edge portion of said actuator housing that defines an opening into a receiving cavity at a distal portion of said through-chamber; and
an actuator shaft rotationally disposed in said through-chamber for rotation about a shaft rotational axis, said actuator shaft having a proximal end configured to couple to the drive assembly, and a distal end terminating in said receiving cavity; and
a rotary valve assembly having a POD housing rotably supporting a valve shaft, said valve shaft having a proximal end portion extending proximally from said POD housing, said POD housing having a proximal insert portion formed and dimensioned for sliding axial receipt in said receiving cavity of said actuator assembly between an unmounted condition, separated from said actuator housing, and a mounted condition, wherein said insert portion is snugly engaged with said circumferential interior wall of actuator housing, and said proximal end portion of said valve shaft is clocked and operably engaged with said distal end of said actuator shaft; and
a quick mount/release mechanism cooperating between said proximal insert portion of said rotary valve assembly and said distal portion of said actuator housing to enable a releasable, quick operable mounting engagement of said rotary valve assembly to said actuator assembly, in said mounted condition, free of any threaded mounting structure.

2. The quick-mount/release, multi-position, micro-fluidic valve system according to claim 1, wherein
said quick mount/release mechanism includes:
a housing first window disposed along the distal portion of said actuator housing, extending from an exterior wall of said actuator housing to said circumferential interior wall for communication into said receiving cavity; and
a first clip assembly having a first button portion coupled to the insert portion of said POD housing for radial movement between a retracted position and an extended condition, and a first biasing device biasing said first button portion radially outward toward said extended condition;
wherein, when said first button portion is in said retracted position, said insert portion of said POD housing can be manually inserted into said interior wall of said actuator assembly such that said valve assembly is movable from said unmounted condition to said mounted condition, and
wherein, when said bottom portion is in said extended condition and said valve assembly is in said mounted condition, said button portion is sized and dimensioned to extend radially through said housing first window in a manner preventing axial separation during operation thereof.

3. The quick-mount/release, multi-position, micro-fluidic valve system according to claim 2, wherein
said quick mount/release mechanism further includes:
a housing second window disposed along the distal portion of said actuator housing at an orientation generally opposite said housing first window, said second window extending from said exterior wall of said actuator housing to said circumferential interior wall for communication into said receiving cavity; and
a second clip assembly having a second button portion coupled to the insert portion of said POD housing at an orientation thereof generally opposite said first clip assembly for radial movement between a respective retracted position and a respective extended condition, and a second biasing device biasing said second button portion radially outward toward said extended condition;
wherein, when said second button portion is in said respective retracted position, said insert portion of said POD housing can be manually inserted into said interior wall of said actuator assembly such that said valve assembly is movable from said unmounted condition to said mounted condition, and
wherein, when said second bottom portion is in said extended condition and said valve assembly is in said mounted condition, said second button portion is sized and dimensioned to extend radially through said housing second window in a manner preventing axial separation during operation thereof.

4. The quick-mount/release, multi-position, micro-fluidic valve system according to claim 3, further including:
an alignment device cooperating between said valve assembly and said actuator housing to assure aligned mounting therebetween in said mounting condition.

5. The quick-mount/release, multi-position, micro-fluidic valve system according to claim 4, wherein
said alignment device includes said first window and corresponding said first button portion having a transverse cross-section footprint different from that of said second window and corresponding second button portion.

6. The quick-mount/release, multi-position, micro-fluidic valve system according to claim 4, wherein
said alignment device includes said first window and corresponding said first button being axially spaced along said rotational axis from that of said second window and corresponding second button portion.

7. The quick-mount/release, multi-position, micro-fluidic valve system according to claim 3, wherein
said first and second biasing device biases the respective first button portion and said second button portion radially outward with a respective radial spring rate in the range of about 5 lbs/in to about 20 lbs/in.

8. The quick-mount/release, multi-position, micro-fluidic valve system according to claim 3, wherein
said first button portion and said second button portion each having a respective substantially planar, upper wall oriented generally perpendicular to said rotational axis such that in the respective extended condition, each said respective upper wall prevents movement of said valve assembly from said mounted condition toward said unmounted condition unless said first button portion and said second button portion, respectively, is moved from said extended condition toward said retracted condition.

9. The quick-mount/release, multi-position, micro-fluidic valve system according to claim 8, wherein
said first button portion and said second button portion each having a steep, outwardly tapered bottom wall that intersects the respective upper wall.

10. The quick-mount/release, multi-position, micro-fluidic valve system according to claim 3, wherein
said first button portion and said second button portion are generally semi-cylindrical, each having a semi-circular transverse cross-sectional dimension,
and each said first window and said second window are defined in part by respective upper interior edges that taper upwardly and inwardly such that when said valve assembly is manually urged from the mounted condition toward the unmounted condition, contact of respective curvilinear upper walls of each said first button portion and said second button portion with the respective upper interior edges of said first window and said second window facilitates respective inward radial movement toward thereof from the extended condition toward the retracted condition.

11. The quick-mount/release, multi-position, micro-fluidic valve system according to claim 10, wherein
said upwardly and inwardly taper of each upper interior edge of the respective first window and said second window is in the range of about 35° to about 55°.

12. The quick-mount/release, multi-position, micro-fluidic valve system according to claim 1, wherein
said valve assembly further includes an annular collar portion coupled to a distal portion of said insert portion of said POD housing, an exterior surface of said insert portion is substantially cylindrical,
wherein, in said mounted condition, said collar portion supportively seats atop said distal edge portion of said actuator housing.

13. The quick-mount/release, multi-position, micro-fluidic valve system according to claim 1, wherein
said quick mount/release mechanism includes a magnetic assembly having a magnet configured to magnetically mount the valve assembly and the actuator assembly in the mounted condition.

14. The quick-mount/release, multi-position, micro-fluidic valve system according to claim 13, wherein
said magnetic assembly includes that said distal edge portion of said POD housing is comprised of a ferrous material, and said annular collar incorporating said magnet as an annular ring magnet such that when said valve assembly is oriented in said mounted condition, said ring magnet and the ferrous material distal edge portion sufficiently magnetically cooperate to enable said releasable, quick operable mounting engagement of said rotary valve assembly to said actuator assembly, free of any threaded mounting structure.

15. The quick-mount/release, multi-position, micro-fluidic valve system according to claim 14, wherein
said magnetic assembly includes a sleeve insert comprised of a ferrous material, and providing said ferrous material distal edge portion at a distal insert portion thereof, said distal insert portion formed and dimensioned for removable sliding receipt of said valve assembly to said mounted condition, and said sleeve insert having a proximal insert portion formed and dimensioned for press-fit receipt into said receiving cavity.

16. The quick-mount/release, multi-position, micro-fluidic valve system according to claim 13, wherein
said magnet is provided by one or more electromagnets powered by said valve assembly.

17. The quick-mount/release, multi-position, micro-fluidic valve system according to claim 1, wherein
said quick mount/release mechanism includes a bayonet assembly having a pair of opposed location pins mounted to said proximal insert portion of said POD housing, and a pair of corresponding J-shaped slots defined by the distal portion of said actuator housing.

18. The quick-mount/release, multi-position, micro-fluidic valve system according to claim 17, wherein
each J-shaped slot includes a respective nub portion formed and dimensioned to retain a respective location pin of said pair of location pins therein when valve assembly is in the mounted condition.

19. The quick-mount/release, multi-position, micro-fluidic valve system according to claim 18, further including:
a spring device coupled between said valve assembly and said actuator assembly, and configured to bias a respective location pin into a respective nub portion of the corresponding J-shaped slot, when said valve assembly is in the mounted condition.

20. The quick-mount/release, multi-position, micro-fluidic valve system according to claim 17, wherein
one location pin of said pair of opposed location pins is a different diameter of that of the other location pin, and each J-shaped slot is dimensioned for receipt of a respective location pin for aligned mounting of said valve assembly to said actuator assembly in the mounted condition.

21. The quick-mount/release, multi-position, micro-fluidic valve system according to claim 1, wherein
said quick mount/release mechanism includes a canted coil spring lock assembly having a canted coil spring mounted to said insert portion of said POD housing.

22. The quick-mount/release, multi-position, micro-fluidic valve system according to claim 21, wherein
said insert portion of said POD housing defines an annular groove formed and dimensioned for receipt of at least an inner portion of said canted coil spring therein.

23. The quick-mount/release, multi-position, micro-fluidic valve system according to claim 22, wherein,
said circumferential interior wall defines an annular channel strategically positioned thereon such that when said valve assembly is positioned at said mounted condition, relative to said actuator assembly, an outer portion of said canted coil spring is simultaneously received in said annular channel.

24. The quick-mount/release, multi-position, micro-fluidic valve system according to claim 1, wherein
said quick mount/release mechanism is configured to withstand eccentric forces in the range of about 8 lbs. to about 10 lbs. generated between the valve assembly and the actuator assembly, to maintain the valve assembly in the mounted condition.
